(19) United States
(12) Patent Application Publication
(10) Pub. No.: US 2006/0007427 A1
(43) Pub. Date: Jan. 12, 2006

(54) Optical transmission apparatus, method for controlling optical transmission system, and optical relay node equipped with wavelength control function

(75) Inventors: Motoyoshi Sekiya, Kawasaki (JP); Yuichi Kawahata, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/986,907

(22) Filed: Nov. 15, 2004

(30) Foreign Application Priority Data
Jul. 6, 2004 (JP) 2004-199345

(51) Int. Cl. G01N 21/00

(52) U.S. Cl. 356/73.1

(57) ABSTRACT

A configuration is designed so as to comprise a light source that transmits light having a certain wavelength, a dispersion compensation module of passing characteristics variable type that compensates for the dispersion of light transmitted from the light source, and control means that control the passing characteristics of the dispersion compensation module so that the amount of the change in the intensity of light having passed through the dispersion compensation module is kept to a minimum. Due to this configuration, it is possible to make the passing characteristics of the dispersion compensation module follow the output wavelength of the light source for highly stable matching only by the stabilization of the output wavelength of the light source without stabilizing the respective wavelengths of both the light source and the dispersion compensation module independently of each other.

### CROSS REFERENCE TO RELATED APPLICATIONS

This application is based on and hereby claims priority to Japanese Application No. 2004-199345 filed on Jul. 6, 2004 in Japan, the contents of which are hereby incorporated by reference.

### BACKGROUND OF THE INVENTION

1. Field of the Invention

The present invention relates to an optical transmission apparatus, a method for controlling an optical transmission system, and an optical relay node equipped with a wavelength control function.

2. Description of Related Art

In an optical transmission system, when wavelength dispersion is large in a transmission path, it is necessary to perform dispersion compensation. A typical dispersion compensation module is a fiber type module (a so-called DCM), but recently, dispersion compensation modules other than the fiber type module, such as a VIPA (Virtually Imaged Phased Array) type module, an etalon type module, an FBG (Fiber Bragg Grating) type nodule, and a waveguide resonance type module have been realized.

Among these, the VIPA type module or an etalon type module using an etalon filter is, in particular, a dispersion compensation device of great possibilities because of being capable of performing dispersion compensation with a simple and compact configuration and of making the amount of dispersion compensation variable. On the other hand, since the configuration needs to utilize resonance, characteristics that the pass band in which dispersion compensation can be performed becomes periodic and, at the same time, that the pass band width for each wavelength is limited (the band becomes narrow) are brought about. One example of the pass band characteristics of the VIPA type module is schematically shown in FIG. 21, in which the peak (central wavelength) of the pass band characteristics (hereinafter, simply referred to also as the “passing characteristics”) appears periodically at intervals as narrow as 50, 100, or 200 GHz (giga-hertz) as shown on the upper side in FIG. 21. By the way, group delay characteristics for wavelengths are shown on the lower side in FIG. 21, in which how the group delay shifts from zero as the wavelength shifts from the peak is shown.

Because of this, in a non-WDM (Wavelength Division Multiplexing) system, a periodic wavelength dispersion compensation module (hereinafter, referred to as a periodic dispersion compensation module or a dispersion compensation module of periodic type) such as the VIPA type module and the etalon type module using an etalon filter having characteristics that the pass band in which dispersion compensation can be performed is a narrow band and the peak of the transmittance appears repeatedly at predetermined intervals, is not used but a dispersion compensation module (DCM) having a wide pass band is generally used.

On the other hand, when a periodic dispersion compensation module is used in a WDM transmission system, since the pass band in which dispersion compensation can be performed is narrow and periodic, as described above, it is necessary to accurately stabilize not only the transmission wavelength of a light source (an optical transmitter) but also the transmission wavelength (the pass band characteristics) of the periodic dispersion compensation module to a grid wavelength λ_{Itu} (hereinafter, referred to as the ITU grid wavelength) being compliant with the ITU (International Telecommunication Union) standards. Because of this, as shown in FIG. 20 for example, an optical transmitter 100 comprises, in addition to an LD module 101 that incorporates a light source (LD) 1010 such as a semiconductor laser diode and a wavelength variation detection circuit 1011 and an LD current control circuit 102, a wavelength detection circuit 103, an LD temperature control circuit 104, etc., for stabilizing wavelength (wavelength lock). And the wavelength detection circuit 103 receives the wavelength variation information from the wavelength variation detection circuit 1011 to detect wavelength variations (errors) and the temperature of the light source 101 is controlled by the LD temperature control circuit 104 so that the detected errors are kept to a minimum (for example, a Peltier element provided in the light source 1010 is controlled). And thus stable matching of the transmission wavelength of the optical transmitter 100 to the corresponding ITU grid wavelength can be realized. On the other hand, the passing characteristics of a periodic dispersion compensation module 200 are also stabilized at the ITU grid wavelength by, for example, stabilizing temperatures.

As described above, it is possible to obtain stable dispersion compensation characteristics by accurately matching both the transmission wavelength of the optical transmitter 100 and the pass band characteristics of the periodic dispersion compensation module 200 to the ITU grid wavelength and stabilizing them. In this, in FIG. 20, the reference number 105 denotes an external modulator (for example, an LN modulator, etc.) that modulates light from the light source 101 using a transmission signal (data) but the external modulator is not necessary in the case of a direct modulation type. The bold solid line arrow denotes an electric signal line and the thin solid line arrow denotes a light signal line.

Conventional technologies relating to stabilization of wavelength further include those proposed in, for example, the following Patent Documents 1 to 3.

The technology proposed in Patent Document 1 provides a multi-wavelength stabilizer capable of stabilizing any one of a plurality of wavelengths that can be output from a tunable laser and also capable of widening a drawing band when the tunable laser is used as a spare. Because of this, the multi-wavelength stabilizer described in the Patent Document 1 comprises an interferometer that makes incident light rays interfere with each other in the period corresponding to double the interval between wavelengths of a channel in a WDM system and, at the same time, which outputs the interfering light from two ports by shifting the light half the period from each other, first and second detection means that detect the respective intensities of output light from the respective ports, and a control means that judges whether the channel fixed to a predetermined wavelength is an even number or an odd number and, at the same time, which controls based on the result of the judgment and the outputs of the respective detection means so that the output wavelength of a laser light source becomes a predetermined wavelength.

Therefore, in the multi-wavelength stabilizer, it is possible to fix the output wavelength of the laser light source to the predetermined wavelength by judging whether the channel fixed to the predetermined wavelength is an even number channel or an odd number channel and sending a control signal to the laser light source so that a detected value (PDo1/PDo2), which is a ratio of the output of the first detection means (PDo1) to the output of the second detection means (PDo2), becomes a target value. Between even number channels or between odd number channels, the same value of PDo1/PDo2 appears in the period double the channel wavelength interval, respectively, therefore, the drawing band of each channel can be widened to double the channel wavelength interval with the predetermined wavelength being at the center.

The technology described in Patent Document 2 relates to an optical transmission apparatus that uses an optical fiber grating (FBG) for dispersion compensation. The optical transmission apparatus arranges an FBG for narrow band dispersion compensation in a transmitter, and also arranges an FBG for dispersion compensation, in which its central wavelength has been set in advance so that the central wavelength is matched to the central wavelength of the transmitter side FBG at the central temperature for use, in a receiver. Then, on the transmission side, the wavelength of a transmission light source is stabilized at the central wavelength of the transmission side FBG by a wavelength stabilization circuit, and at the same time, dispersion compensation is performed. And on the reception side, by performing dispersion compensation using the reception side FBG, deterioration due to the SMP (self phase modulation) effect is suppressed. Moreover, by setting the wavelength band width of the transmission side FBG narrower than the wavelength band width of the reception side FBG, it is possible to control the transmission wavelength to within the reflection band of the reception side FBG even if temperatures change independently in the transmission and reception sides, and the wavelength band width required for the reception side FBG can also be reduced.

The technology described in Patent Document 3 relates to a method and a system capable of stabilizing wavelength with a simple configuration by using QCSE optical detectors that can serve as a filter and a detector at the same time. And optical currents of light emitted from a single light source are detected respectively by first and second QCSE optical detectors that operate on different bias voltages supplied thereto, and the output wavelength of the light source can be stabilized at a predetermined wavelength by controlling the light source so that the detected optical currents are matched to each other.

[Patent Document 1]
Japanese Patent Laid-Open (Kokai) 2000-323784

[Patent Document 2]
Domestic Re-publication of PCT International Publication No. WO97/34379

[Patent Document 3]
Japanese Patent Laid-Open (Kokai) 2003-218461

However, as described above, the pass band for wavelength is limited (the band is narrow) in the periodic dispersion compensation module and it is necessary to accurately match the wavelength of the light source to that of the dispersion compensation module. Technologies for the accurate matching include stabilization of temperatures for a dispersion compensation module (VIPA or etalon filter) and incorporation of a wavelength lock function in a light source for stabilizing wavelengths. As a result, a problem arises in that the configurations of both light source and dispersion compensation module become complex and the cost is increased.

And in a non-WDM long-distance transmission system, a light source, in which the stabilization does not need to the ITU grid wavelength, is used, therefore, a problem is brought about in that a dispersion compensation module having the periodic pass band characteristics cannot be applied to such a system generally.

Moreover, in a WDM transmission system, as described above, it is inefficient for both sides of the light source and the dispersion compensation module to stabilize their wavelengths, and when a plurality of dispersion compensation modules are used in a system, more accurate stability of wavelength will be required. Furthermore, in a WDM long-distance transmission system, when periodic wavelength dispersion compensation modules are used at a plurality of optical relay nodes making up the system, it is necessary to individually stabilize the wavelength of the dispersion compensation modules at all of the nodes and the wavelength of the transmission light source. This is not preferable because the cost of the whole system is increased.

Each of the technologies described in the Patent Documents 1 and 3 relates to the stabilization of wavelength on the transmission side alone, therefore, the relationship between the transmission wavelength and the pass band characteristics of the dispersion compensation module is not at all taken into account. In contrast to this, the technology described in the Patent Document 2 is such one that stabilizes the transmission wavelength at the central wavelength of the transmission side narrow band FBG having the dispersion compensation function provided in the transmitter, therefore, it is unlikely that the configurations of the light source and the dispersion compensation module become complex but various problems will be brought about because the output wavelength of the light source is controlled.

In other words, to control the output wavelength of a light source, temperatures are generally controlled using a Peltier element, etc., but this not only increases power consumption but also imposes a large load on the light source depending on the variable width of the output wavelength, and as a result, the life of the light source is reduced and anomaly may be caused to occur. On the other hand, if the central emission wavelength is changed, there may be a case where unexpected output power variations may be caused to occur and the entire system may be adversely affected. Moreover, in the case of a WDM transmission system, as described above, the output wavelength of the light source is generally stabilized at the ITU grid wavelength, therefore, the technology described in the Patent Document 2, which changes the output central emission wavelength of the light source, cannot be applied to the system.

### SUMMARY OF THE INVENTION

The present invention has been developed with the above-mentioned problems being taken into account and the object thereof is to make it possible to make the passing characteristics of a dispersion compensation module follow the output wavelength of a light source for highly stable matching only by means of the wavelength stabilization of the output wavelength of the light source without performing the respective wavelength stabilization of both the light source and the dispersion compensation module independently of each other by making it possible to match the peak of the passing characteristics of the dispersion compensation module to the output wavelength of the light source without controlling the output wavelength of the light source.

In order to achieve the above-mentioned object, an optical transmission apparatus according to the present invention is characterized in a manner that the optical transmission apparatus comprises an optical transmission section that outputs light having a certain wavelength, a wavelength deviation applying section that controls the optical transmission section to change the wavelength of the output light, an optical device that receives the output light from the optical transmission section and the device has transmission wavelength characteristics that the transmittance changes according to the wavelength of the received light, a monitor section that monitors the intensity of output light from the optical device, and a control means that controls the wavelength deviation applying section and which also controls the transmission wavelength characteristics of the optical device so that the amount of the change in the intensity of the output light from the optical device according to the change in the output light wavelength of the optical transmission section is kept to a minimum.

Another optical transmission apparatus according to the present invention is characterized in a manner that the optical transmission apparatus comprises
a light source that outputs light having a certain wavelength, a dispersion compensation module that compensates for the wavelength dispersion of light transmitted from the light source and whose passing wavelength characteristics can be controlled, and a control means that controls the passing characteristics of the dispersion compensation module so that the amount of the change in the intensity of light with respect to the change in the wavelength passing through the dispersion compensation module is kept to a minimum.

The control means can be composed of a wavelength deviation applying section that gives a wavelength deviation to the transmission light from the light source, a monitor section that monitors the intensity of light having passed through the dispersion compensation module, a detection section that detects the ratio of the amount of the change in the wavelength deviation given by the wavelength deviation applying section to the amount of the change in the intensity of light monitored by the monitor section and the sign thereof, and a dispersion-compensation-module passing-characteristics control section that controls the passing characteristics of the dispersion compensation module based on the ratio and sign detected by the detection section so that the amount of the change in the intensity is kept to a minimum.

And also, the dispersion compensation module can be composed of an etalon filter having a light incident surface whose light reflectance is less than 1 and a light reflection surface that reflects light that transmits the light incident surface and whose light reflectance is less than 1, or can be composed of a plurality of stacked etalon filters whose reflectance is less than 1.

Moreover, a method for controlling an optical transmission system according to the present invention, in the optical transmission system that provides a light source that transmits light having a certain wavelength, an optical transmission path that transmits light from the light source and a plurality of optical relay nodes interposed in the optical transmission path and having a disperse compensation module of passing characteristics variable type that compensates for the dispersion of the transmission light, is characterized in that the wavelength of the light source is shifted and the wavelength shift information is transferred to each of the optical relay nodes, and each of the optical relay nodes controls the passing characteristics of the dispersion compensation module based on light having passed through the dispersion compensation module of its own node and the transferred wavelength shift information so that the amount of the change in the intensity of light having passed through the dispersion compensation module is kept to a minimum.

And also, another method for controlling an optical transmission system according to the present invention, in the optical transmission system being a wavelength-multiplexed optical transmission system that provides a plurality of light sources that transmit light of different wavelengths, an optical transmission path that transmits light from each of the light sources as a wavelength-multiplexed light, and a plurality of optical relay nodes having a periodic dispersion compensation module having periodic passing characteristics that the pass band is a narrow band and the peak of the transmittance appears repeatedly at predetermined intervals and whose passing characteristics are variable, is characterized in that the wavelength of any one of the light sources having a standard wavelength is shifted and the wavelength shift information is transferred to each of the optical relay node, and each of the optical relay nodes controls the passing characteristics of the dispersion compensation module based on the output light of the standard wavelength from the dispersion compensation module of its own node and the transferred wavelength shift information of the standard wavelength so that the amount of the change in the intensity of the light having the standard wavelength having passed through the dispersion compensation module is kept to a minimum, and each of the optical relay nodes controls the transmission wavelength of the light sources other than that having the standard wavelength so that the amount of the change in the intensity of light having a wavelength other than the standard wavelength having passed through the dispersion compensation module is kept to a minimum.

Moreover, an optical relay node equipped with a wavelength control function according to the present invention is an optical relay node in a wavelength-multiplexed optical transmission system that provides a plurality of light sources that transmit light of different wavelengths, an optical transmission path that transmits light from each of the light sources as a wavelength-multiplexed light, and a plurality of optical relay nodes interposed in the optical transmission path. And the optical relay node is characterized in a manner that the optical relay node provides a periodic dispersion compensation module having periodic passing characteristics that the pass band is a narrow band and the peak of the transmittance appears repeatedly at predetermined intervals and whose passing characteristics are variable, a wavelength-shift-information reception means that receives the wavelength shift information given to any one of the light sources having a standard wavelength, and a control means that controls the passing characteristics of the dispersion compensation module based on the output light of the standard wavelength having passed through the periodic compensation module and the wavelength shift information received by the wavelength-shift-information reception means so that the amount of the change in the intensity of light having the standard wavelength having passed through the dispersion compensation module is kept to a minimum.

According to the present invention described above, excellent dispersion compensation characteristics can be obtained because it is possible to make the passing characteristics of a dispersion compensation module follow the output wavelength of a light source for highly stable matching only by means of the wavelength stabilization of the output wavelength of the light source without performing the respective wavelength stabilization of both the light source and the dispersion compensation module independently of each other. In particular, since the passing characteristics of a dispersion compensation module are changed without changing the central emission wavelength of a light source, not only the power consumption but also the load imposed on the light source can be reduced. Moreover, unexpected output power variations due to the change of the central emission wavelength of the light source can be prevented. When the present dispersion compensation system is applied to a WDM transmission system, it will be possible to make the passing characteristics of the dispersion compensation module follow the ITU grid wavelength for stabilization if the output wavelength of the light source is set and stabilized in advance in accordance with the ITU grid wavelength, therefore, application to the WDM transmission system is easy.

### BRIEF DESCRIPTION OF THE DRAWINGS

FIG. 1 is a block diagram showing a configuration of a dispersion compensation system (an optical transmission apparatus) in a first embodiment of the present invention;

FIG. 2 (a) is a diagram showing an example of group delay characteristics and passing characteristics for the wavelength of a dispersion compensation module of VIPA type as a periodic dispersion compensation module shown in FIG. 1;

FIG. 2 (b) is a diagram showing an example of group delay characteristics and passing characteristics of a dispersion compensation module of etalon type as a periodic dispersion compensation module shown in FIG. 1;

FIG. 3 (a) and FIG. 3 (b) are diagrams each for explaining the operation principles of the dispersion compensation system shown in FIG. 1;

FIG. 4 is a block diagram showing a configuration example in the case where the periodic dispersion compensation module shown in FIG. 1 is of VIPA type;

FIG. 5 is a diagram for explaining a method for changing the wavelength setting of the dispersion compensation module of VIPA type shown in FIG. 4;

FIG. 6 is a block diagram showing a configuration example in the case where the periodic dispersion compensation module shown in FIG. 1 is of etalon type;

FIG. 7 is a block diagram showing another configuration example in the case where the periodic dispersion compensation module shown in FIG. 1 is of etalon type;

FIG. 8 is a diagram for explaining a method for changing the wavelength setting of the dispersion compensation module of etalon type shown in FIG. 6;

FIG. 9 is a block diagram showing a configuration in which a plurality of dispersion compensation modules of etalon type shown in FIG. 6 is connected in tandem for a broader band;

FIG. 10 is a block diagram showing a modification example of the dispersion compensation system shown in FIG. 1;

FIG. 11 is a block diagram showing another modification example of the dispersion compensation system shown in FIG. 1;

FIG. 12 is a block diagram showing a configuration of a WDM transmission system in a second embodiment of the present invention;

FIG. 13 is a block diagram showing a configuration of an important part of a standard wavelength optical transmitter shown in FIG. 12;

FIG. 14 is a block diagram showing a configuration of an important part of an optical relay node shown in FIG. 12;

FIG. 15 is a diagram for explaining a method for matching the transmission wavelength of a non-standard wavelength optical transmitter to the central wavelength of each dispersion compensation module in the WDM transmission system shown in FIG. 12;

FIG. 16 is a block diagram showing a configuration of an important part of the non-standard wavelength optical transmitter shown in FIG. 15;

FIG. 17 is a block diagram showing a configuration of an important part of the optical relay node shown in FIG. 15;

FIG. 18 is a flowchart for explaining a method for matching the central wavelength of each dispersion compensation module to the transmission wavelength of the standard wavelength optical transmitter in the WDM transmission system shown in FIG. 12;

FIG. 19 is a flowchart for explaining a method for matching the transmission wavelength of the non-standard wavelength optical transmitter to the central wavelength of each dispersion compensation module in the WDM transmission system shown in FIG. 12;

FIG. 20 is a block diagram for explaining a conventional wavelength stabilization technology; and

FIG. 21 is a diagram schematically showing an example of passing band characteristics and group delay characteristics for the wavelength of the conventional VIPA.

### DESCRIPTION OF THE PREFERRED EMBODIMENTS

[A] Explanation of First Embodiment

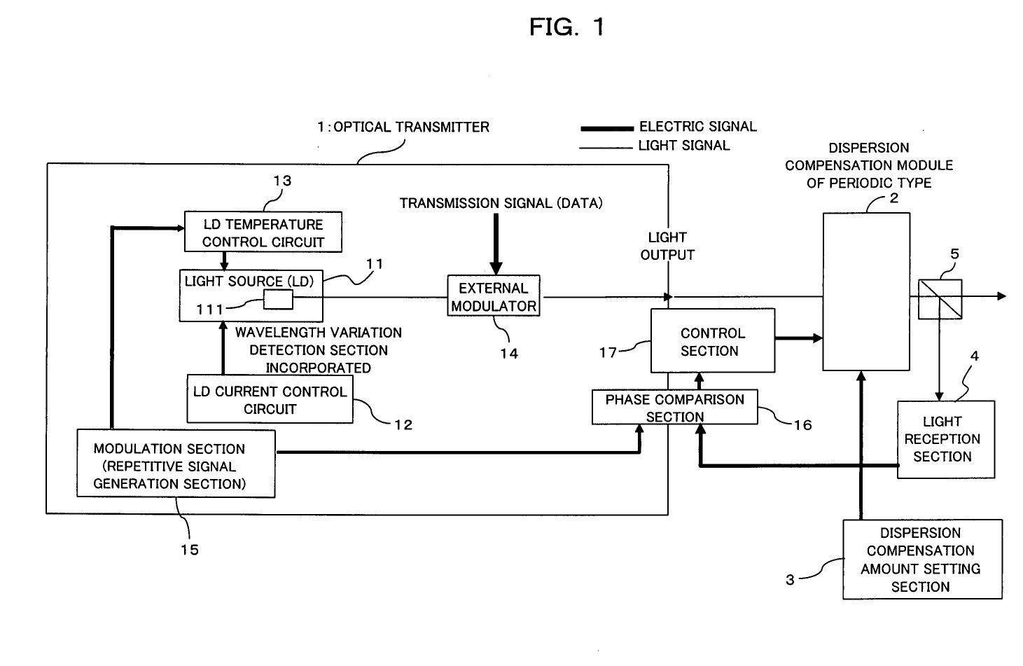

FIG. 1 is a block diagram showing a configuration of a dispersion compensation system (an optical transmission apparatus) in a first embodiment of the present invention. The dispersion compensation system shown in FIG. 1 comprises an optical transmitter 1 which provides a light source (LD) unit 11 containing a light emitting element 111 such as a semiconductor laser diode (LD) and functioning as an optical transmission section for outputting light having a certain wavelength, an LD current control circuit 12, an LD temperature control circuit 13, an external modulator 14, a modulation section (a repetitive signal generation section) 15, a phase comparison section 16, and a control section 17, and further comprises a dispersion compensation module of periodic type 2, a dispersion compensation amount setting section 3, a light reception section 4, and an optical coupler 5. The above-mentioned phase comparison section 16 and control section 17 can be arranged inside the optical transmitter 1 or outside the optical transmitter 1 (for example, inside an optical relay node in which the dispersion compensation module of periodic type 2 is provided).

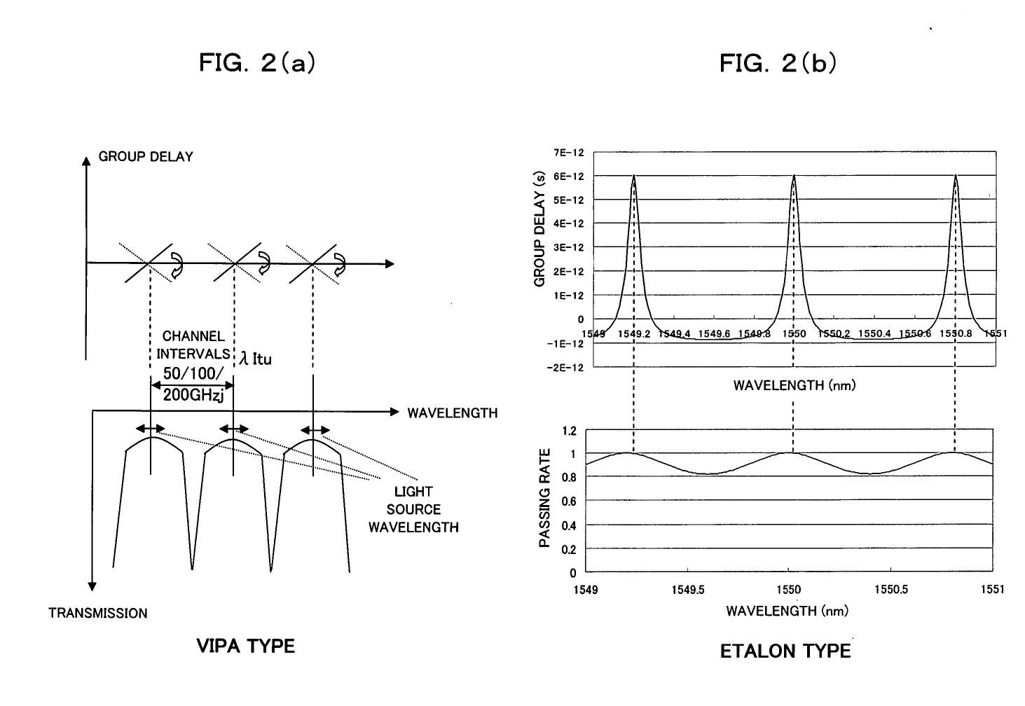

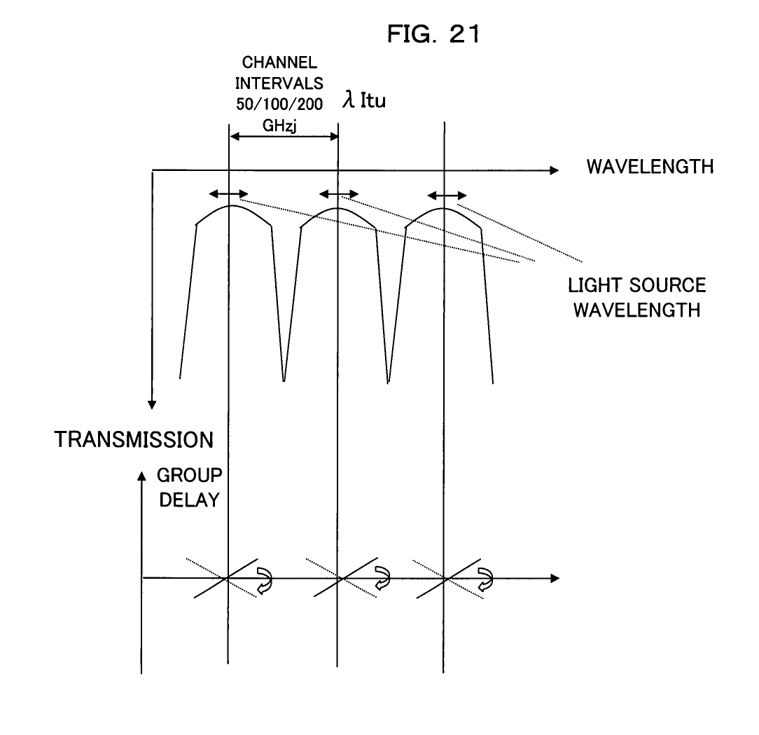

The dispersion compensation module of periodic type 2 has periodic passing characteristics for the wavelength (characteristics that the periodic transmittance peak appears repeatedly at predetermined intervals for the wavelength) and dispersion compensation modules having such passing characteristics include, for example, a VIPA type and a reflection filter type employing an etalon filter, etc. Similar to those shown in FIG. 21, the VIPA type has the group delay characteristics (shown on the upper side in FIG. 2 (a)) and the passing characteristics (shown on the lower side in FIG. 2 (a)) repeated at intervals such as 50, 100, and 200 GHz, and the etalon (the reflection filter) type has the group delay characteristics (shown on the upper side in FIG. 2 (b)) and the passing characteristics (shown on the lower side in FIG. 2 (b)) repeated at intervals of, for example, 0.8 nm (nano meters) for the wavelength.

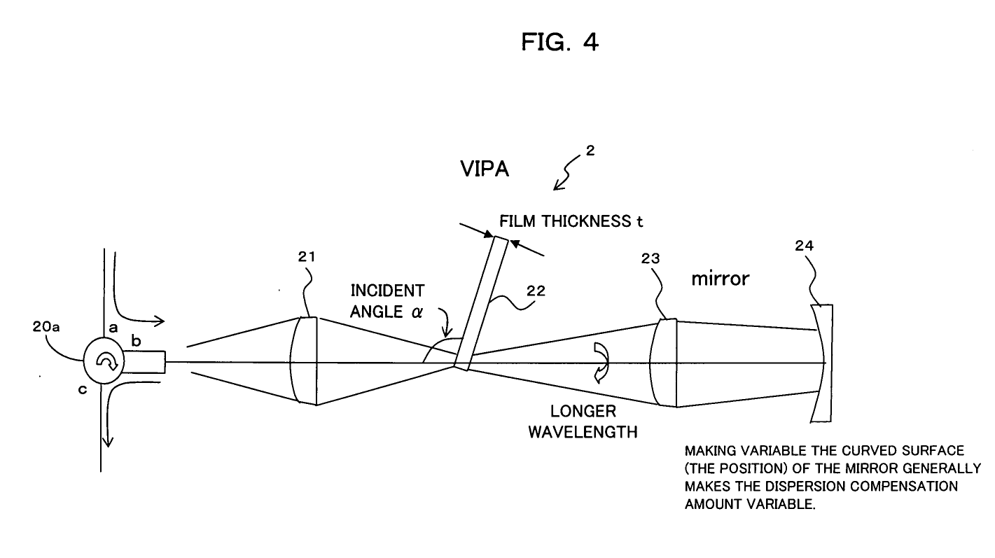

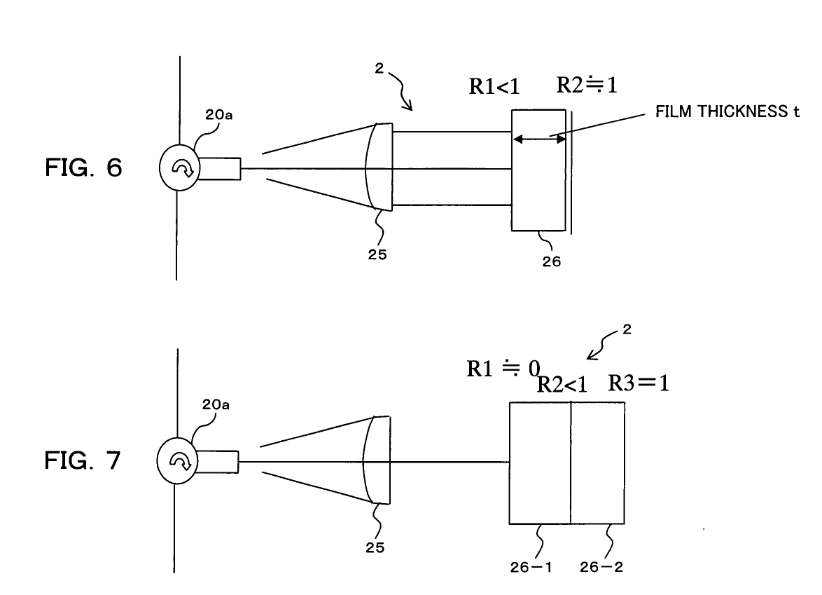

FIG. 4 shows a configuration example of a periodic dispersion compensation module of VIPA type and FIG. 6 shows that of an etalon type. The dispersion compensation module of VIPA or etalon type has transmission wavelength characteristics that the transmittance varies depending on the wavelength of the received light and functions as an optical device capable of controlling the transmission wavelength characteristics.

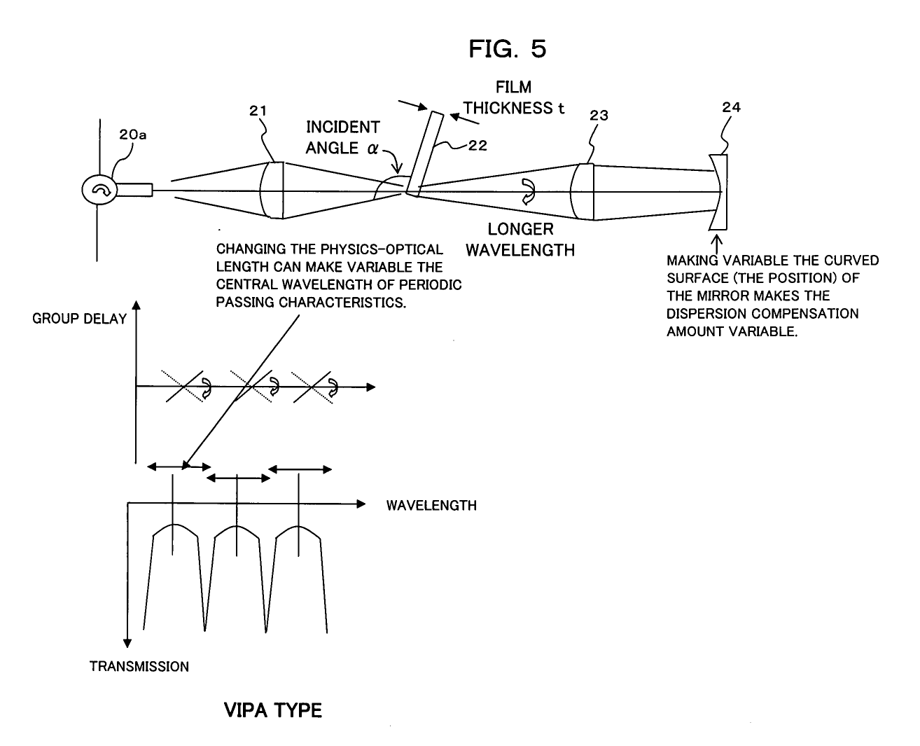

As shown in FIG. 4, the dispersion compensation module 2 of VIPA type comprises, for example, a line focus lens 21 that converges output light (collimated light) of the light source 11 into line, an angle dispersion element (a VIPA plate) 22, both sides of which, that is, both sides of a thin plate having a film thickness t are coated with reflection films, and whose reflectance of the reflection film on the side in opposition to the line focus lens 21 is set to a value slightly less than 100%, and which produces output light having an outgoing angle in accordance with the wavelength of an incident light, a focus lens 23 that converges output light of the VIPA plate 22 into point, and a three-dimensional reflection mirror 24 having a three-dimensional curved shape on the light incidence side. As shown schematically in FIG. 5, by making variable the incident angle α of light incident on the VIPA plate, the central wavelength (the transmittance peak) of the periodic passing characteristics can be made variable, and the dispersion compensation amount can be made variable by translating the three-dimensional reflection mirror 24 (translation in the direction perpendicular to the plane of the paper on which FIG. 4 is shown) to change the position of the mirror curved surface at which the light from the focus lens 23 converges, thereby varying the amount of the change in the optical path length of the reflected light in the wavelength band of the light incident on the three-dimensional mirror.

The period of the transmittance peak is determined based on the film thickness t described above. In FIG. 4, symbol 20a denotes an optical circulator that guides light from a port a to a port b, that is, to the VIPA plate 22 and light from the port b, that is, the reflected light from the VIPA plate 22 to a port c. Since the principles of dispersion compensation (action) by the dispersion compensation module 2 of VIPA type are widely known, no detailed explanation will be given here.

On the other hand, as shown in FIG. 6, the periodic dispersion compensation module 2 of etalon type can be comprised of, for example, a line conversion lens 25 and an etalon filter (a resonator of reflection type) 26, on both sides of which, that is, on both sides of a thin plate having a film thickness t, reflection films R1 and R2 are formed. If the reflectance of the reflection film R2 is set to 1 (total reflection), light having all the wavelengths is reflected, therefore, the periodic passing characteristics as shown in FIG. 2 (b) cannot be obtained. In other words, the passing characteristics in this case appear flat in an idealistic situation. On the other hand, since phase characteristics are that the amount of the change in phase differs depending on the wavelength, the periodic group delay characteristics are brought about as a result. By the way, the period thereof is determined based on the film thickness t of the etalon filter 26.

However, if the passing characteristics are flat as described above, the transmittance peak does not exist (in other words, there is no slope part of the passing characteristics), therefore, the control to match the wavelength of the light source unit 11 (the light emitting element 111) to the transmittance peak cannot be done any longer, as will be described later.

In the first embodiment, therefore, the reflectance of the reflection film R2 is made less than 1 (substantially equal to 1) purposely so that a part of light will leak out. Due to this, there are produced wavelengths of light that leaks out and other wavelengths of light that does not leak out during the process of internal multiplex reflection depending on the film thickness t, therefore, the dispersion compensation module of periodic type 2 having the periodic passing characteristics for the wavelength as shown in FIG. 2 (b) can be realized.

The dispersion compensation module of periodic type 2 having the periodic passing characteristics can also be realized by, as shown in FIG. 7 for example, combining two etalon filters 26-1 and 26-2 or more etalon filters having a reflectance less than 1. In FIG. 7, the reflectance of the reflection film R1 of the etalon filter 26-1 on the light incidence side is set to a value slightly greater than zero, that is, a value substantially equal to zero, the reflectance of the reflection film R2 located on the boundary between the etalon filters 26-1 and 26-2 is set to a value less than 1, and the reflectance of the reflection film R3 of the etalon filter 26-2 on the side in opposition to the reflection film R2 is set to 1 (total reflection).

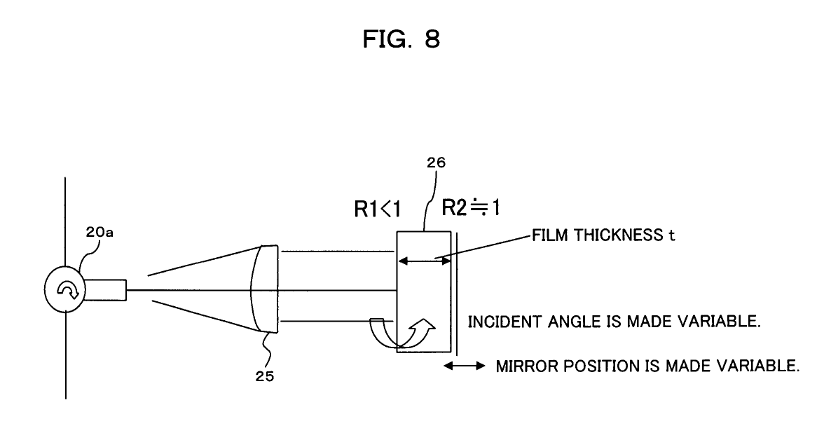

The setting of wavelength of the periodic dispersion compensation module 2 of etalon type can be performed by making variable the incident angle of light to the etalon filter 26 (26-1, 26-2) or by making variable the temperature of the etalon filter 26 (26-1, 26-2) to make the film thickness t variable and thereby, making variable the position of the reflection film R2 (R3), as shown schematically, for example, in FIG. 8.

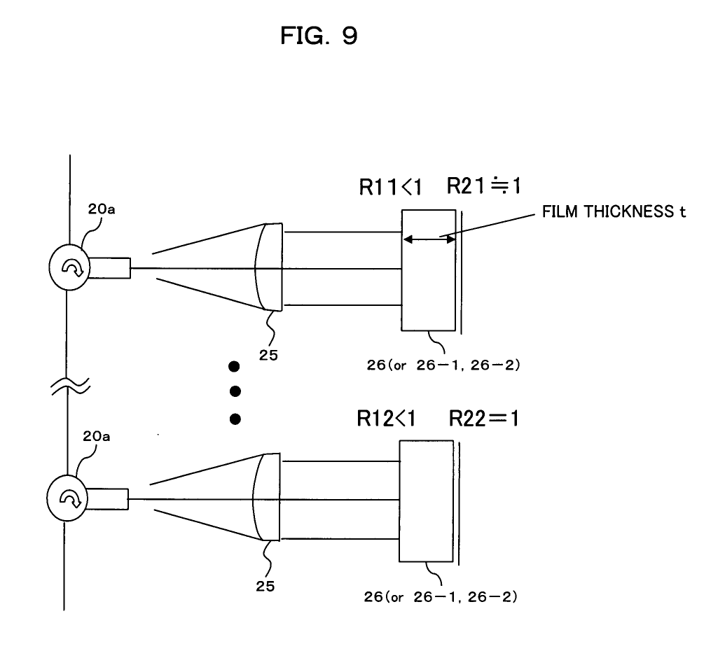

Moreover, in the case of the etalon type, for example as shown in FIG. 9, it is possible to widen the band of the periodic passing characteristics by connecting in tandem a plurality of the dispersion compensation module 2 (the line conversion lens 25 and etalon filter 26) having the configuration shown in FIG. 6 (or the dispersion compensation module 2 having the configuration shown in FIG. 7) via the optical circulators 20a. In this case, however, it is sufficient if there exists at least one of the reflection film R2 whose reflectance is less than 1.

Next, in FIG. 1, the dispersion compensation amount setting section 3 sets the amount of dispersion compensation of the dispersion compensation module of periodic type 2, and in the optical transmitter 1, the light source unit 11 outputs light having a predetermined wavelength (ITU grid wavelength) by driving the light emitting element 111, the LD current control circuit 12 supplies and controls the drive current for the light source unit 11 (light emitting element 111) (referred to simply as “light source 11”, hereinafter), and the LD temperature control circuit 13 is composed of elements such as a Peltier element and prevents shift in wavelength caused by variations in temperature by keeping the temperature of the light source 11 constant. The external modulator 14 modulates the output light of the light source 11 using the main signal (data) to be transmitted and, for example, an LN modulator or the like can be employed.

The modulation section (wavelength deviation applying section) 15 changes the output wavelength (transmission wavelength) of the light source 11, in other words, applies a wavelength deviation of low frequency (slight modulation) by applying a repetitive signal of low frequency (for example, a sinusoidal wave signal of low frequency) to the LD temperature control circuit 13 to control the temperature by the LD temperature control circuit 13. As described above, when a wavelength deviation of low frequency is applied to the output wavelength of the light source 11, the passing loss (transmittance) of the dispersion compensation module of periodic type 2 changes and the wavelength deviation is converted into a modulation in intensity (change in intensity).

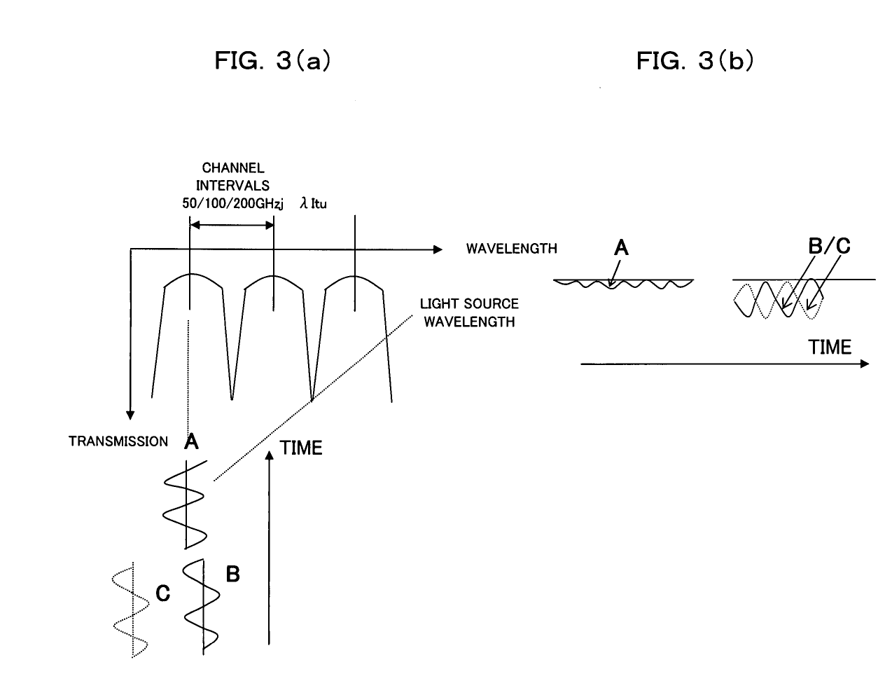

For example, if a case where the VIPA is used is taken as an example for explanation, when the output wavelength of the light source 11 is matched or substantially matched to the peak value (central wavelength) of the periodic passing characteristics of the periodic dispersion compensation module 2 (VIPA) [refer to the symbol A in FIG. 3 (a)], the output light of the periodic dispersion compensation module 2 changes into intensity-modulated light to which a slight modulation in intensity has been applied, as shown by the solid line A in FIG. 3 (b). In contrast to this, when the output wavelength of the light source 11 is shifted toward longer wavelengths from the central wavelength of the above-mentioned passing characteristics as shown by the symbol B in FIG. 3 (a), the output light of the periodic dispersion compensation module 2 changes into an intensity-modulated light in phase with the output light of the light source 11, as shown by the solid line B in FIG. 3 (b) And conversely, when the output wavelength of the light source 11 is shifted toward shorter wavelengths from the central wavelength as shown by the symbol C in FIG. 3 (a), the output light of the periodic dispersion compensation module 2 changes into an intensity-modulated light in opposite phase with the output light, as shown by the dotted line C in FIG. 3 (b).

Therefore, it will be possible to detect whether the output wavelength of the light source 11 is matched or substantially matched to the central wavelength of the passing characteristics of the dispersion compensation module 2 and whether the output wavelength is shifted toward longer wavelengths or shorter lengths with respect to the central wavelength by comparing the phase of light having passed through the periodic dispersion compensation module (referred to simply as a “dispersion compensator”, hereinafter) 2 with the phase of light before passing therethrough.

In the first embodiment, therefore, the light reception section (monitor section) 4 that receives (monitors) a part of the output light of the dispersion compensator 2 branched by the photo coupler 5, and the phase comparison section 16 that compares the phase of a signal that applies a modulation to the output light of the light source 11 from the modulation section 15 with the phase of light monitored by the light reception section 4 are provided so that whether the output light of the dispersion compensator 2 is an intensity-modified light in phase or in opposite phase with the output light of the light source 11 can be detected. However, an object whose phase which is to be compared with the output light of the dispersion compensator 2 by the phase comparison section 16 can be the output light of the light source 11 before passing through the dispersion compensator 2. In other words, the phase comparison section 16 functions as a detection section that detects the ratio of the amount of the change in the above-mentioned wavelength deviation applied by the modulation section 15 to the amount of the change in the intensity of light monitored by the light reception section 4 and the sign thereof (in phase/the opposite phase).

Then, the control section (dispersion compensator passing characteristics control section) 17 adaptively controls the passing characteristics of the periodic dispersion compensator 2 based on the detection results (the above-mentioned ratio and sign) by the phase comparison section 16. For example, in the case where the dispersion compensator 2 is of VIPA type, the control section 17 controls the incident angle α of light to the VIPA plate 22 to a greater value so as to shift the passing characteristics (the transmittance peak) of the dispersion compensator 2 toward longer wavelengths, when “in phase” is the detection result of the phase comparison section 16, as described in FIG. 5. On the other hand, when “the opposite phase” is the detection result, the control section 17 conversely controls the above-mentioned incident angle α to a smaller value so as to shift the passing characteristics toward shorter wavelengths. Thus, the control section 17 operates in such a manner that the amount of the change in the intensity of light with respect to the change in the wavelength passing through the dispersion compensator 2 is kept to a minimum [state shown by the symbol A in FIG. 3 (b)], in other words, in such a manner that the central wavelength of the passing characteristics of the dispersion compensator 2 is matched to the output wavelength of the light source 11.

On the other hand, in the case where the dispersion compensator 2 of etalon type is used, the control section 17 operates in such a manner that, as in the case of the VIPA type, the central wavelength of the passing characteristic of the dispersion compensator 2 is matched to the output wavelength of the light source 11 by means of the shift of the passing characteristics (the transmittance peak) of the dispersion compensator 2 by controlling the incident angle of light to the etalon filter 26 (26-1, 26-2) or controlling the film thickness t by the temperature control of the etalon filter 26 (26-1, 26-2) based on the detection results of the phase comparison section 16, as described above with reference to FIG. 8.

In other words, when “in phase” is the detection result by the phase comparison section 16, the control section 17 shifts the passing characteristics (the transmittance peak) of the dispersion compensator 2 toward longer wavelengths by controlling the incident angle of light to the etalon filter 26 (26-1, 26-2) to a greater value or controlling the film thickness t to a greater value by the control of the temperature of the etalon filter 26 (26-1, 26-2) toward higher temperatures. On the other hand, when “opposite phase” is the detection result, the control section 17 shifts the passing characteristics of the dispersion compensator 2 toward shorter wavelengths and matches the central wavelength of the passing characteristics of the dispersion compensator 2 to the output wavelength of the light source 11 by conversely controlling the above-mentioned incident angle to a smaller value or controlling the film thickness t to a smaller value by the control of the temperature of the etalon filter 26 (26-1, 26-2) toward lower temperatures.

It is, therefore, possible to highly stably match the output wavelength of the light source 11 to the passing characteristics of the dispersion compensator 2 and obtain excellent dispersion compensation characteristics, because the central wavelength of the passing characteristics of the dispersion compensator 2 can be made to follow the output wavelength of the light source 11 for matching with each other. As a result, in the first embodiment also, when the dispersion compensation system is applied to a WDM transmission system, it will be possible to stabilize the passing characteristics of the dispersion compensator 2 at the ITU grid wavelength if the output wavelength of the light source 11 is set and stabilized in advance in accordance with the ITU grid wavelength.

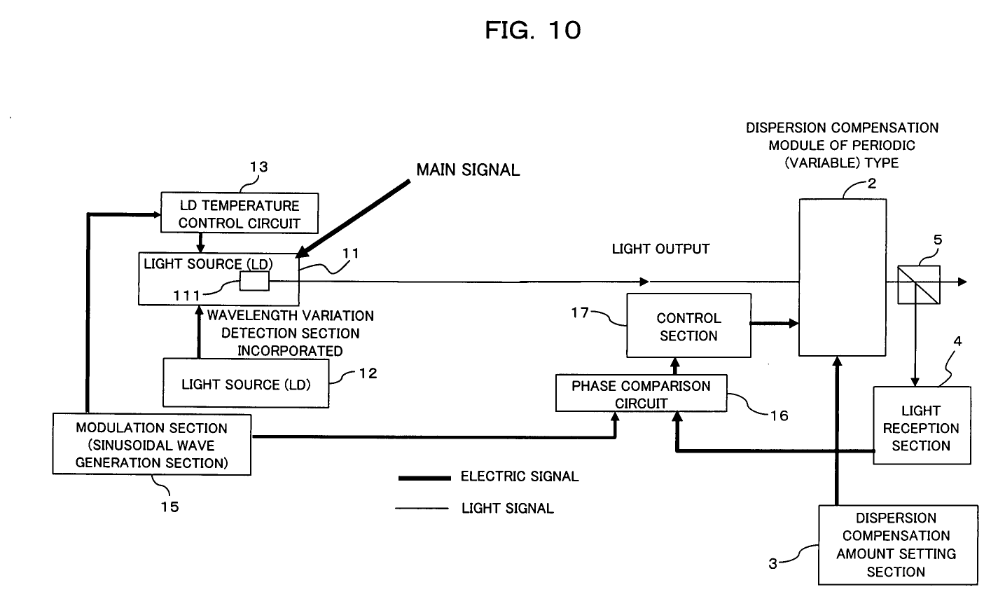

By the way, it is possible to configure the dispersion compensation system shown in FIG. 1 in the manner as shown in FIG. 10. In other words, in the system shown in FIG. 1, the output light of the light source 11 is modulated by the external modulator 14 using the main signal, but it is also possible to directly modulate the light source 11 (light emitting element 111) using the main signal as shown in FIG. 10. In this case also, as in the configuration employing the external modulator 14, it will be possible for the control section 17 to make the central wavelength of the passing characteristics of the dispersion compensator 2 follow the output wavelength of the light source 11 for stabilization based on the phase comparison results by the phase comparison section 16.

In other words, the light reception section 4, the modulation section 15, the phase comparison section 16, and the control section 17 described above function as a wavelength lock mechanism (control means) that adjusts the passing characteristics of the dispersion compensator 2 adaptively in accordance with the output wavelength of the light source 11 and which stabilizes (locks) the output wavelength of the light source 11 in the vicinity of the passing characteristics peak of the dispersion compensator 2, and control, to be more specific, the transmission wavelength characteristics of the dispersion compensator 2 by controlling the LD temperature control circuit 13 that serves as a wavelength deviation applying section so that the amount of the change in the intensity of the output light of the dispersion compensator 2 in accordance with the change in the output light wavelength of the light source 11 is kept equal to a predetermined threshold value or less.

Although a dispersion compensator having periodic characteristics is taken as an example for explanation of the first embodiment, examples are not limited to this, and it is obvious that the central wavelength in the transmission band can be controlled in accordance with the output wavelength of a light source by the method shown in the first embodiment provided that a dispersion compensator has characteristics that the passing characteristics change in the band near the central wavelength and the central wavelength in the transmission band can be controlled.

In the dispersion compensation system in the first embodiment, which is configured in such a manner as described above, a slight modulation (wavelength deviation) is applied in advance to the output light of the light source 11 from the modulation section 15, the degree to which the output wavelength of the light source 11 is shifted from the central wavelength of the passing characteristics of the dispersion compensator 2 is detected by the phase comparison section 16 based on the comparison between the phase of the output light before passing through the dispersion compensator 2 and the phase after passing therethrough, and the passing characteristics of the dispersion compensator 2 are controlled adaptively for stabilization by the control section 17 in such a manner that the shift is eliminated.

Therefore, it is not necessary to stabilize the respective wavelengths of both the light source 11 and the dispersion compensator 2 independently of each other and excellent dispersion compensation characteristics can be obtained, because the passing characteristics of the dispersion compensator 2 can be made to follow the output wavelength of the light source 11 for highly stable matching by the wavelength stabilization of only the output wavelength of the light source 11. Particularly, in the case of the first embodiment, the passing characteristics of the dispersion compensator 2 are changed by means of a mechanical control without changing the central emission wavelength of the light source 11, therefore, it will be possible to reduce not only power consumption but also the load of the light source 11. Moreover, it is also possible to prevent unexpected variations in output power due to the change of the central emission wavelength of the light source 11.

When the dispersion compensation system is applied to a WDM transmission system, it will be possible to make the passing characteristics of the dispersion compensator 2 follow the ITU grid wavelength for stabilization if the output wavelength of the light source 11 is set and stabilized in advance in accordance with the ITU grid wavelength, therefore, application to the WDM transmission system is easy.

(A1) Explanation of Modification Example

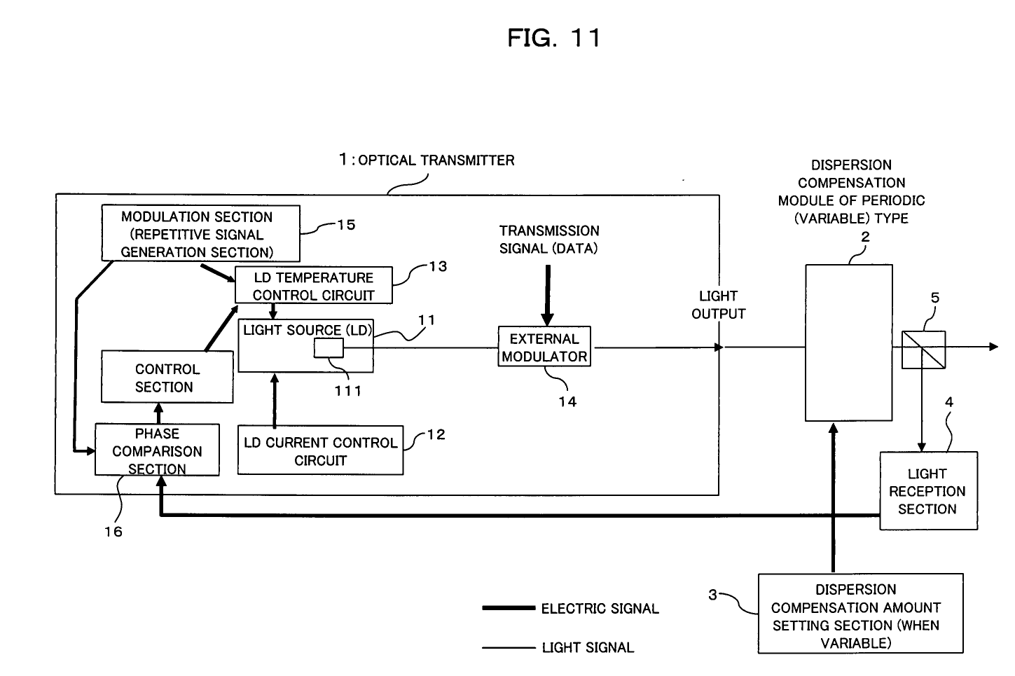

FIG. 11 is a block diagram showing a modification example of the dispersion compensation system described above. The dispersion compensation system shown in FIG. 11 differs from the system described above with reference to FIG. 1 in that the control section 17 is configured so as to control the output wavelength of the light source 11, instead of the output wavelength of the dispersion compensator 2, based on the result of the phase comparison by the phase comparison section 16.

In other words, when the result of the phase comparison by the phase comparison section 16 is “in phase”, the control section 17 in this modification example shifts the output wavelength of the light source 11 toward shorter wavelengths by reducing the temperature of the LD temperature control circuit 13 and, on the other hand, when the detection result is “opposite phase”, the control section 17 conversely shifts the output wavelength of the light source 11 toward longer wavelengths by raising the temperature of the LD temperature control circuit 13, and thus the control section 17 operates so that the output wavelength of the light source 11 is matched to the central wavelength of the passing characteristics of the dispersion compensator 2.

In other words, the light reception section 4, the LD temperature control circuit 13, the modulation section 15, the phase comparison section 16, and the control section 17 described above in this modification example function as a wavelength lock mechanism that stabilizes (locks) the output wavelength of the light source 11 in the vicinity of the passing characteristics peak of the dispersion compensator 2 by making the output wavelength of the light source 11 follow the passing characteristics of the dispersion compensator 2.

In this case also, therefore, it is not necessary to stabilize the respective wavelengths of both the light source 11 and the dispersion compensator 2 independently of each other and excellent dispersion compensation characteristics can be obtained, because the output wavelength of the light source 11 and the passing characteristics of the dispersion compensator 2 can be matched each other highly stably by only the stabilization of the passing characteristics of the dispersion compensator 2. Then, when the dispersion compensation system is applied to a WDM transmission system, it will be possible to stabilize the output wavelength of the light source 11 at the ITU grid wavelength if the passing characteristics of the dispersion compensator 2 are set and stabilized in advance in accordance with the ITU grid wavelength.

Moreover, in the dispersion compensator 2 of VIPA type, as described above, it is possible to make variable the peak (the central wavelength) of the periodic passing characteristics by changing, for example, the incident angle α of light to the VIPA plate 22, the physics-optical length, that is, the film thickness t of the VIPA plate 22 (when there exists an air gap sandwiched by the mirrors making up the VIPA plate 22, the gap length is changed), or by changing the index of refraction when there exists a dielectric between the mirrors making up the VIPA plate 22, etc. In the dispersion compensator 2 of etalon type, on the other hand, it is possible to make variable the central wavelength of the periodic passing characteristics by changing the incident angle of light to the etalon filter 26 (26-1, 26-2) or the film thickness t. However, in this modification example, what is necessary is only to control the output wavelength of the light source 11, therefore, it is not necessarily needed to make variable the periodic passing characteristics of the dispersion compensator 2.

[B] Explanation of Second Embodiment

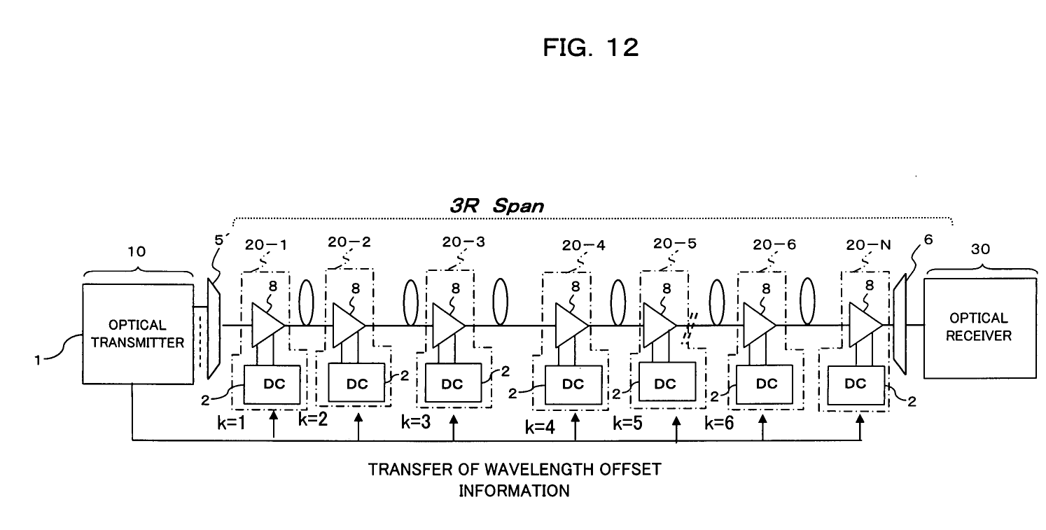

FIG. 12 is a block diagram showing a configuration of a WDM transmission system according to a second embodiment of the present invention. The WDM transmission system shown in FIG. 12 comprises a transmission side terminal station node 10 having a plurality of optical transmitters 1 that each transmits light having a different wavelength respectively and a WDM coupler 5′ that multiplexes the wavelength of each output light of the respective optical transmitters 1 and outputs to an optical transmission path as WDM light, a reception side terminal station node 30 having a WDM coupler 6 that branches the WDM light from the optical transmission path for each wavelength and a plurality of optical receivers 7 that each receives the signal light of each wavelength branched by the WDM coupler 6, and optical relay nodes (OADM nodes) 20-1 to 20-N (N is an integer equal to or greater than 1) interposed in the transmission path, the number of which corresponds to a distance through which the WDM light is transmitted as it is between the terminal station nodes 10 and 30. This distance is called as 3R span.

The optical relay nodes 20-i (i=1 to N) are each provided with an optical amplifier 8 such as an EDFA (Erbium Doped Fiber Amplifier) and a periodic dispersion compensator (DC) 2 of VIPA or etalon type, described above, and thereby, the WDM light is transmitted between the above-mentioned terminal station nodes 10 and 30 while being amplified at a time and dispersion is compensated for.

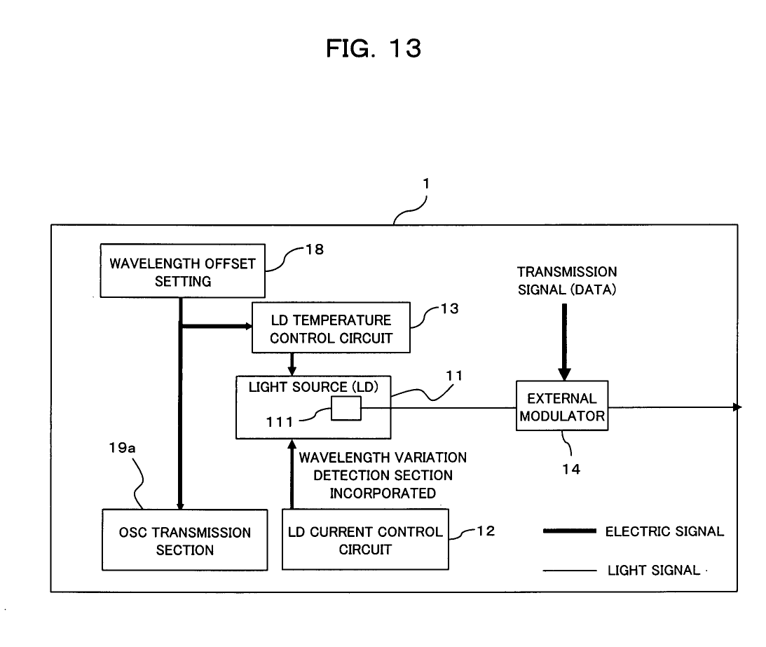

In the transmission side terminal station node 10, an optical transmitter (a standard wavelength optical transmitter) 20-1 (in FIG. 13, optical transmitter 1) which is one of the optical transmitters 1 and which transmits light having a wavelength that serves as a standard when the central wavelength of the passing characteristics of the dispersion compensator 2 in each optical relay node 20-i is controlled in the same manner as that described in the first embodiment, comprises a light source 11 (light emitting element 111), an LD current control circuit 12, an LD temperature control circuit 13, and an external modulator 14, which are the same as or similar to those already described above, and further comprises a wavelength offset setting section 18 and an OSC (optical service channel) transmission section 19a, as shown, for example, in FIG. 13.

The wavelength offset setting section 18 changes the LD temperature of the light source 11 and applies an amount of wavelength offset Δλₘ (m is an integer variable equal to or greater than zero and increased by one each time the wavelength offset is given, as will be described later) to the output light of the light source 11 by giving a predetermined amount of wavelength offset (shift) (the initial value is zero) to the LD temperature control circuit 13. And the OSC transmission section 19a provides a function to notify each optical relay node 20-i on the downstream side of information about the amount of wavelength offset Δλₘ by the wavelength offset section 18 as wavelength offset information through OSC.

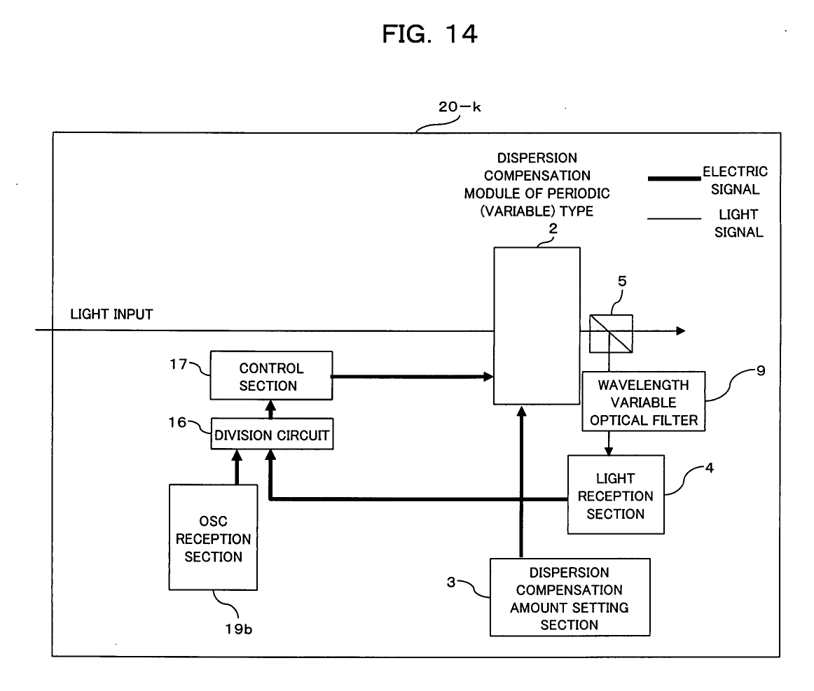

On the other hand, each optical relay node 20-i comprises a dispersion compensator 2, a dispersion compensation amount setting section 3, a light reception section 4, an optical coupler 5, and a control section 17, which are the same as or similar to those already described above, and further comprises a division circuit 16 that functions as the already-described phase comparison section 16 and a wavelength variable optical filter 9, as shown, for example, in FIG. 14.

The wavelength variable optical filter 9 transmits only the light having the standard wavelength as monitor light among the output light (WDM light) of the dispersion compensator 2 and the monitor light is to be received by the division circuit 16 through the light reception section 4. An OSC reception section (wavelength shift information reception means) 19b receives the wavelength offset information sent through OSC and supplies the information to the division circuit 16.

The division circuit 16 detects the shift of the standard wavelength from the central wavelength of the passing characteristics of the dispersion compensator 2 corresponding to the standard wavelength based on the monitor light having the standard wavelength sent from the light reception section 4 and the wavelength offset information (the amount of wavelength offset Δλₘ) received by the OSC reception section 19b, and the control section 17 controls the central wavelength of the dispersion compensator 2 based on the detection result so that the above-mentioned shift is eliminated.

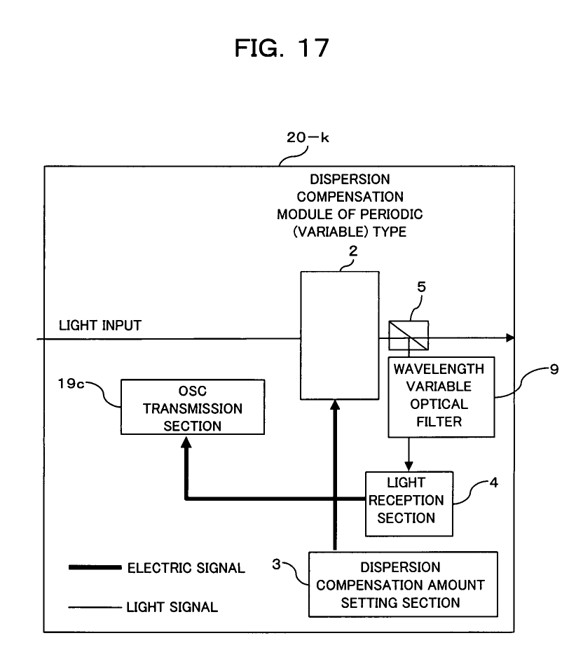

Moreover, each optical relay node 20-i is also provided with an OSC transmission section 19c that notifies each optical relay node 20-i on the upstream side and the transmission side terminal station node 10 of information about the intensity of the output light (selected by the wavelength variable optical filter 9) whose wavelength is other than the standard wavelength of the dispersion compensator 2 received by the light reception section 4 through OSC, as shown, for example, in FIG. 17.

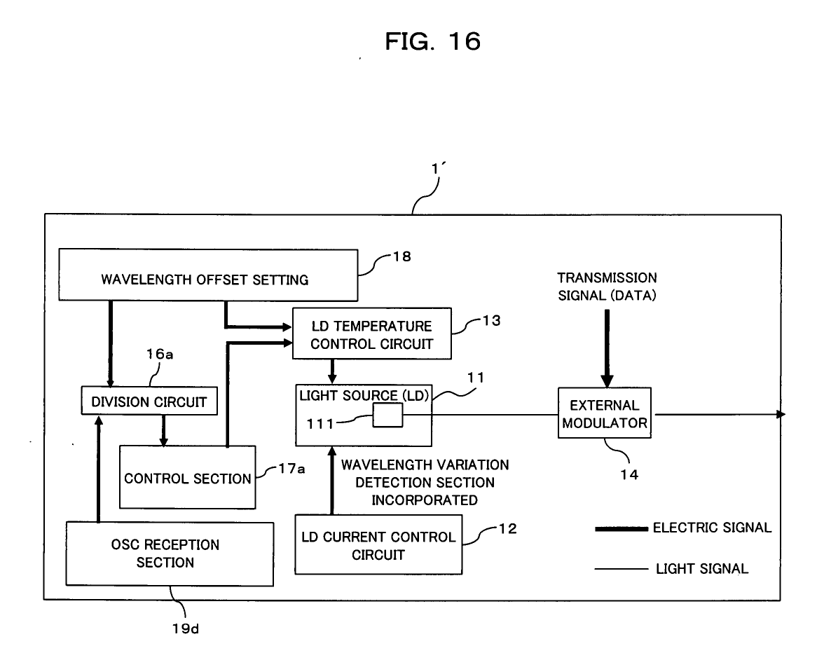

Next, an optical transmitter (a non-standard wavelength optical transmitter) 1 that transmits light having a wavelength other than the standard wavelength (denoted by a symbol 1′ for simplification of explanation, hereinafter) comprises, as shown, for example, in FIG. 16, a light source 11 (a light emitting element 111), an LD current control circuit 12, an LD temperature control circuit 13, and an external modulator 14, which are the same as or similar to those already described above, and further comprises a division circuit 16a having a function equivalent to that of the already-described phase comparison section 16, a control section 17a having a function equivalent to that of the already-described control section 17, and an OSC reception section 19d, and the wavelength offset amount Δλₘ can be set to the LD temperature control circuit 13 and the division circuit 16a.

The OSC reception section 19d receives the intensity information about the standard wavelength transferred from the OSC transmission section 19c of the optical relay node 20-i on the downstream side via OSC and supplies the information to the division circuit 16a. And the division circuit 16a detects the shift of the output wavelength of the light source 11 from the central wavelength of the passing characteristics of the dispersion compensator 2 corresponding to the output wavelength based on the intensity information and the wavelength offset amount Δλₘ.

Then, the control section 17a makes the output wavelength of the light source 11 follow the central wavelength of the dispersion compensator 2 by controlling the temperature of the light source 11 using the LD temperature control circuit 13 in such a manner that the wavelength shift detected by the division circuit 16a is eliminated.

Due to the configuration described above, in the WDM transmission system according to the second embodiment, it will be possible to set the central wavelength of the standard wavelength of the periodic dispersion compensator 2 to the center of the transmission wavelength of the standard wavelength optical transmitter 1 as follows: the wavelength of the light source 11 of the standard wavelength optical transmitter 1 is shifted (offset) purposely and the information is transferred to each optical relay node 20-i via OSC; and in each optical relay node 20-i, the power of light having the standard wavelength after having passed through the periodic dispersion compensator 2 is monitored, the ratio of the wavelength offset amount to the amount of the change in the intensity and the magnitude thereof are calculated, and the calculated ratio of the setting of the central wavelength to the standard wavelength of the periodic dispersion compensator 2 is adjusted to become smaller. Moreover, after the above-mentioned adjustment of the standard wavelength, it will be possible to make settings so that the transmission wavelengths of the respective light sources 11 of the other non-standard wavelength optical transmitters 1′ can be matched to the central wavelength of the passing characteristic of the dispersion compensator 2, respectively.

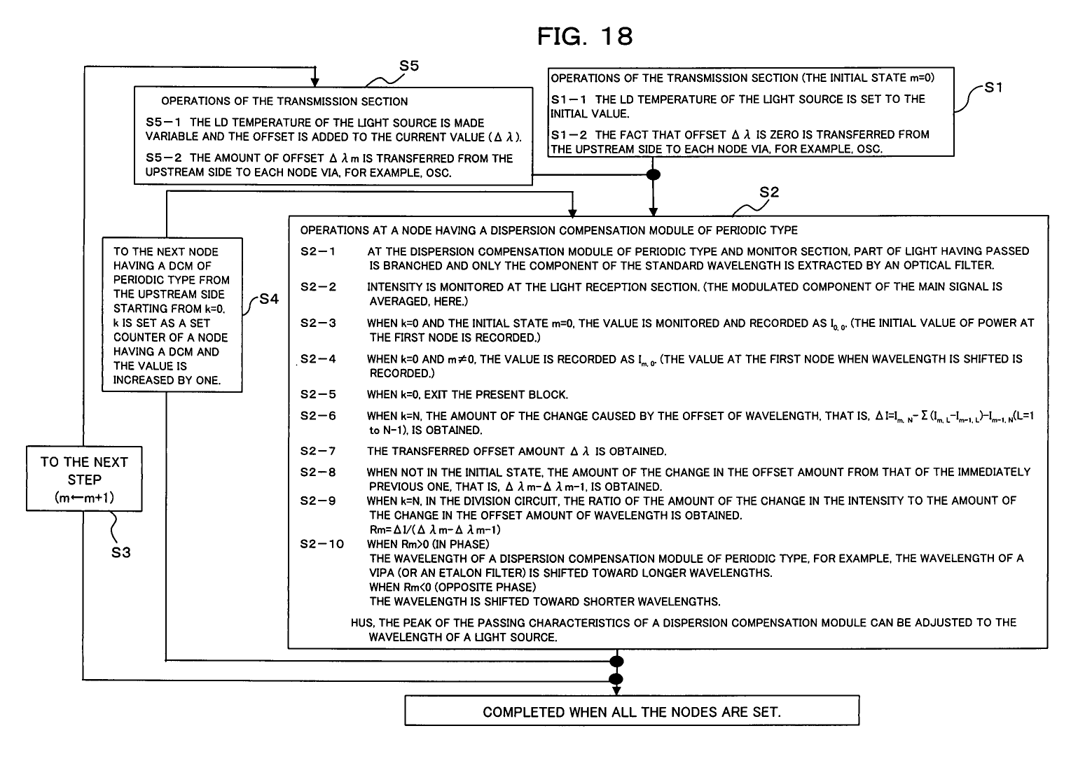

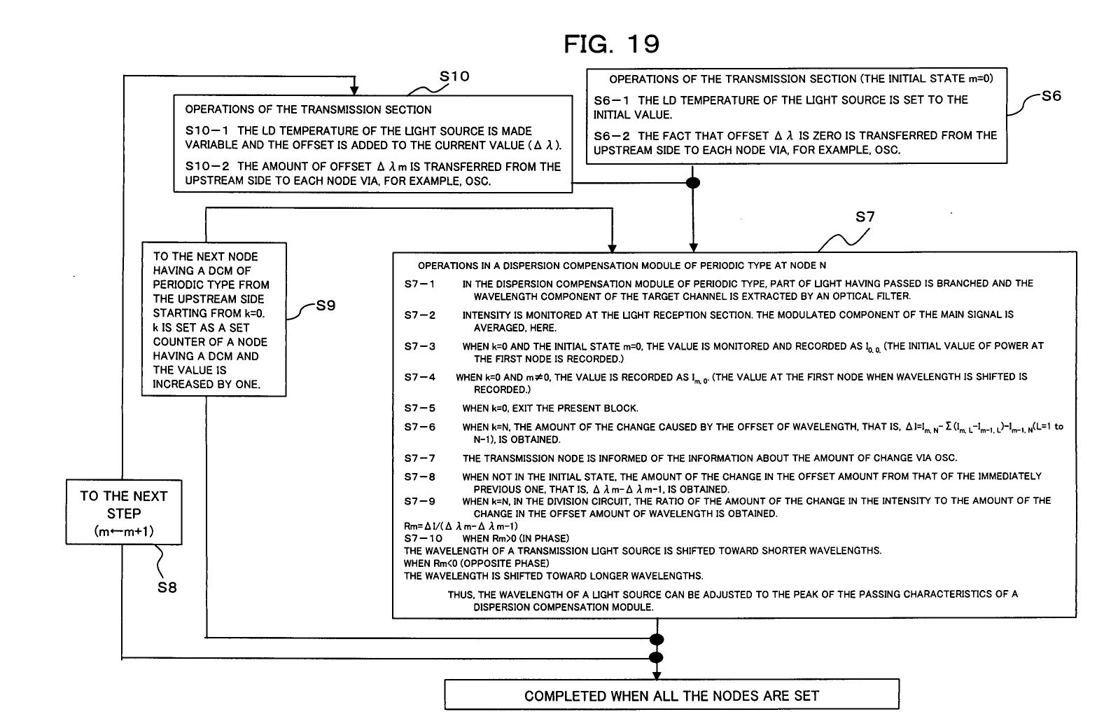

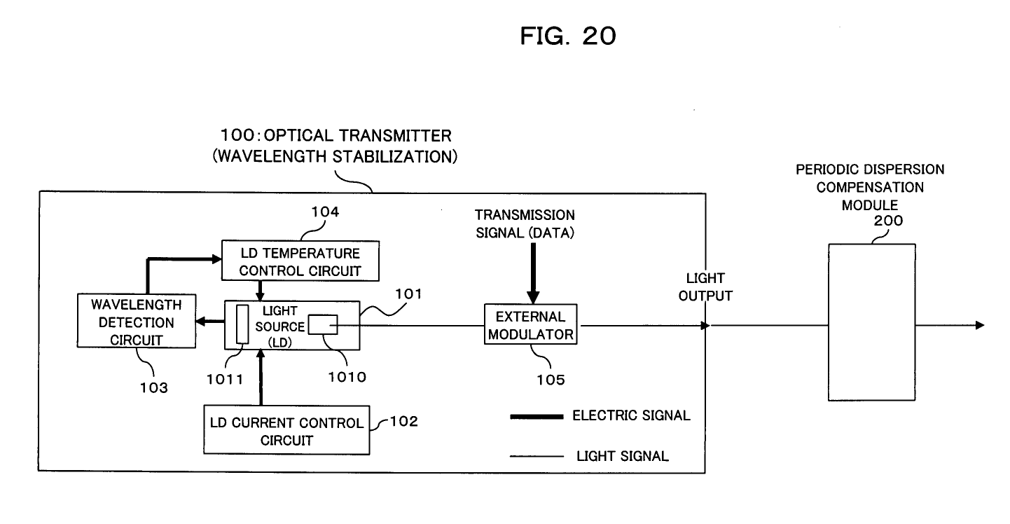

A detailed procedure is explained below with reference to FIG. 18 and FIG. 19.

First, the action to match the central wavelength of the dispersion compensator 2 of each optical relay node 20-i to the output wavelength (the standard wavelength) of the standard wavelength optical transmitter 1 in a WDM transmission system is explained (refer to FIG. 18). In the following explanation, the variable k represents, as shown in FIG. 12, a set counter value that is increased by one each time the node 20-i (having the periodic dispersion compensator 2), the wavelength of which is the adjustment target, moves to the next one on the downstream side, where the initial value is zero.

As shown in FIG. 18, in step S1 for initial settings, the LD temperature of the light source 1 of the standard wavelength optical transmitter 1 is set to the initial value by the LD temperature control circuit 13 [at this time, the wavelength offset amount Δλₘ (m=0) is zero] (step S1-1), and the fact that the wavelength offset amount Δλₘ is zero is transferred from the upstream side to each optical relay node 20-i on the downstream side by, for example, the OSC transmission section 19a via OSC (step S1-2).

In the optical relay node 20-1, in step S2 for wavelength adjustment, a part of light having passed through the periodic dispersion compensator 2 is branched by the optical coupler 5, only the component of the standard wavelength is extracted by the wavelength variable optical filter 9 (step S2-1), and the intensity of the extracted component of the standard wavelength is monitored by the light reception section 4 (step S2-2). At this time, the modulated component of the main signal is averaged.

When k=0 and the initial state m=0, the optical relay node 20-1 records the intensity of the monitored standard wavelength as I_{0, 0} (that is, the initial value of power at the first node is recorded) (step S2-3) When k=0 and m≠0 (that is, in a state in which the wavelength offset has been given once or more times), the intensity of the standard wavelength monitored by the light reception section 4 is recorded as I_{m, 0} (the value at the first node when the wavelength is shifted is recorded) (step S2-4).

After this, when k=0, the present block (step S2 for wavelength adjustment) is quitted (step S2-5), m is increased by 1 (m←m+1) (step S3) and, at the same time, k is increased by 1 (step S4) and step S5 for wavelength offset is performed in the standard wavelength optical transmitter 1 by the wavelength offset setting section 18. In other words, the LD temperature of the light source 11 is changed, the offset Δλₘ is given to the current value of the standard wavelength (step S5-1) and the wavelength offset amount Δλₘ is transferred from the upstream side to each optical relay node 20-i by the OSC transmission section 19a via OSC (step S5-2).

Next, step S2 for wavelength adjustment is performed again but now k=1, therefore, in the first optical relay node 20-1, the amount of the change ΔI, which is caused by the wavelength offset, in the intensity of light having the standard wavelength is obtained by the following expression (1) (step S2-6). In the following expression (1), L=1 to N−1:
αI=I_{m, N}−Σ(I_{m, L}−I_{m-1, L})−I_{m-1, N} (1)
where N=1.

Then, the wavelength offset amount Δλₘ transferred via OSC is obtained (step S2-7) and when not in the initial state (that is, m≠0), the amount of the change from the wavelength offset amount of the immediately previous one, that is Δλₘ−Δλₘ₋₁, is obtained (step S2-8), and when k=N, the ratio of the amount of the change in the intensity to the amount of the change in the wavelength offset amount Rₘ=ΔI/(Δλₘ−Δλₘ₋₁) is obtained by the division circuit 16 (step S2-9).

As a result, when Rₘ>0 (in phase), the control section 17 shifts the central wavelength of the periodic dispersion compensator 2 toward longer wavelengths and conversely, when Rₘ<0 (opposite phase) the central wavelength is shifted toward shorter wavelengths (step S2-10). Due to this, it will be possible to match the central wavelength (the peak) of the passing characteristics of the dispersion compensator 2 in the optical relay node 20-1 to the wavelength of the light source 11 of the standard wavelength optical transmitter 1.

After this, it will be possible to match the central wavelength of each dispersion compensator to the wavelength of the light source 11 sequentially from the upstream side by increasing m and k by 1 for the other optical relay nodes 20-2 to 20-n (steps S3 and S4) and performing step S5 for wavelength offset and step S2 for wavelength adjustment (calculation is performed using the expression (1) on the assumption that k=N).

Next, the action to match the transmission wavelength of the optical transmitters 1′ (the non-standard wavelength optical transmitters) having a wavelength (a channel) other than the standard wavelength to the central wavelength of each dispersion compensator 2 that has been matched to the standard wavelength as described above is explained below (refer to FIG. 19).

As shown in FIG. 19, each non-standard wavelength optical transmitter 1′ sets the LD temperature of the light source 11 to the initial value using the LD temperature control circuit 13 as step S6 for initial settings [at this time, the wavelength offset amount Δλₘ (m=0) is zero] (step S6-1), and the fact that the wavelength offset amount Δλₘ (m=0) is zero is transferred from the upstream side to each optical relay node 20-i on the downstream side by, for example, the OSC transmission section 19a via OSC (step S6-2).

In each optical relay node 20-1, in step S7 for wavelength adjustment, first, a part of light having passed through the periodic dispersion compensator 2 is branched by the optical coupler 5, and only the components of the wavelengths, which are the adjustment targets having a wavelength other than the standard wavelength, are extracted by the wavelength variable optical filter 9 (step S7-1), and the intensity of the extracted component of the standard wavelength is monitored by the light reception section 4 (step S7-2). At this time, the modulated component of the main signal is averaged.

Then, when k=0 and the initial state m=0, the optical relay node 20-1 records the intensity of the monitored standard wavelength as I_{0, 0} (that is, the initial value of power at the first node is recorded) (step S7-3). When k=0 and m≠0 (that is, in a state in which the wavelength offset has been given once or more times), the intensity of the standard wavelength monitored by the light reception section 4 is recorded as I_{m, 0} (the value at the first node when the wavelength is shifted is recorded) (step S7-4).

After this, when k=0, the present block (step S7 for wavelength adjustment) is quitted (step S7-5), m is increased by 1 (m←m+1) (step S8) and, at the same time, k is increased by 1 (step S9) and step S10 for wavelength offset is performed in the non-standard wavelength optical transmitter 1′ by the wavelength offset setting section 18. In other words, the LD temperature of the light source 11 is changed, the offset Δλₘ is given to the current value of the transmission wavelength (step S10-1) and the wavelength offset amount Δλₘ is transferred from the upstream side to each optical relay node 20-i by the OSC transmission section 19a via OSC (step S10-2).

Next, step S7 for wavelength adjustment is performed again but now k≠0, therefore, in the k-th optical relay node 20-k, the amount of the change ΔI, which is caused by the wavelength offset, in the intensity of light having the standard wavelength is obtained by the following expression (2) (step S7-6) In the following expression (2), L=1 to N−1:
ΔI=I_{m, N}−Σ(I_{m, L}−I_{m-1, L})−I_{m-1, N} (2)

Then, the optical relay node 20-1 notifies the non-standard wavelength optical transmitter 1′ of information about the amount of the change ΔI from the OSC transmission section 19c via OSC (step S7-7).

In the non-standard wavelength optical transmitter 1′, if not in the initial state (m=0), the amount of the change from the wavelength offset amount of the immediately previous one, that is Δλₘ−Δλₘ₋₁, is obtained (step S7-8), and when k=N, the ratio of the amount of the change in the intensity to the amount of the change in the wavelength offset amount Rₘ=ΔI/(Δλₘ−Δλₘ₋₁) is obtained by the division circuit 16a (refer to FIG. 16) (step S7-9).

As a result, when Rₘ>0 (in phase), the control section 17a shifts the transmission wavelength of light source 11 toward shorter wavelengths by controlling the LD temperature using the LD temperature control circuit 13 and conversely, when Rₘ<0 (opposite phase), the transmission wavelength of the light source 11 is shifted toward longer wavelengths (step S7-10). Due to this, it will be possible to match the transmission wavelength of the light source 11 in the non-standard wavelength optical transmitter 1′ to the central wavelength (the peak) of the passing characteristics of the dispersion compensator 2 in the optical relay node 20-1.

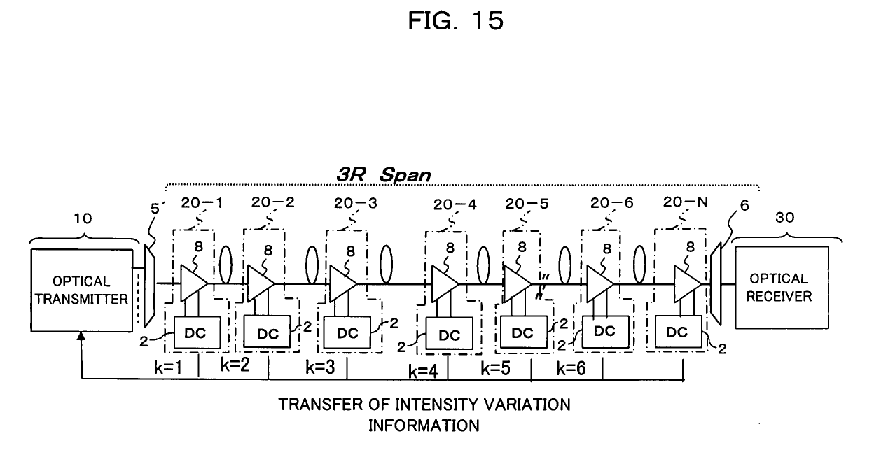

After this, it will be possible to match the transmission wavelength (the channel other than the standard wavelength) of the light source 11 in each non-standard wavelength optical transmitter 1′ to the peak of the passing characteristics of the dispersion compensator 2 in each node 20-k by increasing m and k by 1 (steps S8 and S9) and by performing step S10 for wavelength offset and step S7 for wavelength adjustment (refer to FIG. 15).

As described above, according to the second embodiment, it will be possible to match the peak of the passing characteristics of the dispersion compensator 2 in each optical relay node 20-k to the center of the transmission wavelength of the light source 11 in a system having a plurality of the periodic dispersion compensators 2 in a WDM transmission system as follows: the wavelength of the light source 11 is shifted purposely and the information is transferred to each optical relay node 20-k; and in each optical relay node 20-k, the power of light after having passed through the periodic dispersion compensator 2 in the node 20-k is monitored, the ratio of the wavelength shift amount to the amount of the change in the intensity and the magnitude thereof are calculated, the wavelength setting of the periodic dispersion compensator 2 is adjusted so that the calculated ratio of the change in intensity becomes smaller.

As a result, even when many dispersion compensators 2 are used in a system such as in a WDM long-distance transmission system, it is not necessary to adjust the central wavelength of the dispersion compensator 2 for each node 20-k and the cost of the whole system can be reduced. Particularly, in the case of the second embodiment, the central wavelength of the dispersion compensator 2 is adjusted sequentially from the node 20-k on the upstream side, therefore, a more accurate wavelength setting can be realized.

Moreover, in the process described above, adjustment is first made for the standard wavelength and after the matching of the central wavelength of the dispersion compensator 2 was performed, the transmission wavelength of the light source 11 of other channels are adjusted so as to be matched to the passing characteristics of the dispersion compensator 2, therefore, it is possible to highly accurately match the transmission wavelength of the light source 11 of each channel and the peak of the passing characteristics of each dispersion compensator 2 to the ITU grid wavelength, and also to realize excellent dispersion compensation characteristics in a WDM long-distance transmission system.

The present invention is not limited to each of the embodiments described above, and it is obvious that various modifications can be done without departing from the scope of the present invention.

As described above, according to the present invention, it is not necessary to stabilize the respective wavelengths of both the light source and the dispersion compensator independently of each other, and excellent dispersion compensation characteristics can be obtained because the passing characteristics of the dispersion compensator can be made to follow the output wavelength of the light source for highly stable matching only by the wavelength stabilization of the output wavelength of the light source, and therefore, it can be thought that the present invention is extremely useful in the optical transmission technology field.

What is claimed is:

1. An optical transmission apparatus comprising:
an optical transmission section that outputs light having a certain wavelength;
a wavelength deviation applying section that controls said optical transmission section to change the wavelength of the output light;
an optical device that receives the output light from said optical transmission section and said device has transmission wavelength characteristics whose transmittance changes according to the wavelength of the received light;
a monitor section that monitors the intensity of the output light from said optical device; and
a control means that controls said wavelength deviation applying section and which also controls the transmission wavelength characteristics of said optical device so that the amount of the change in the intensity of the output light from said optical device according to the change in the output light wavelength of said optical transmission section is kept to a minimum.

2. An optical transmission apparatus comprising:
an optical transmission section that outputs light having a certain wavelength;
a wavelength deviation applying section that controls said optical transmission section to change the wavelength of the output light;
an optical device that receives the output light from said optical transmission section and said device has transmission wavelength characteristics whose transmittance changes according to the wavelength of the received light;
a monitor section that monitors the intensity of the output light from said optical device; and
a control means that controls said wavelength deviation applying section and which also controls the transmission wavelength characteristics of said optical device so that the amount of the change in the intensity of the output light from said optical device according to the change in the output light wavelength of said optical transmission section is kept equal to a predetermined threshold value or less.

3. An optical transmission apparatus comprising:
alight source that outputs light having a certain wavelength;
a dispersion compensation module that compensates for the wavelength dispersion of light transmitted from said light source and whose passing wavelength characteristics can be controlled; and
a control means that controls the passing characteristics of said dispersion compensation module so that the amount of the change in the intensity of light with respect to the change in the wavelength of light passing through said dispersion compensation module is kept to a minimum.

4. The optical transmission apparatus according to claim 3, wherein,
said control means comprises:
a wavelength deviation applying section that gives a wavelength deviation to the transmission light of said light source;
a monitor section that monitors the intensity of light having passed through said dispersion compensation module;
a detection section that detects the ratio of the amount of the change in the wavelength deviation given by said wavelength deviation applying section to the amount of the change in the intensity of light monitored by said monitor section and the sign thereof; and
a dispersion-compensation-module passing-characteristics control section that controls the passing characteristics of said dispersion compensation module based on the ratio and sign detected by said detection section so that the amount of the change in the intensity is kept to a minimum.

5. The optical transmission apparatus according to claim 3, wherein,
said control means comprises:
a wavelength deviation applying section that gives a wavelength deviation to the transmission light of said light source;
a monitor section that monitors the intensity of light having passed through said dispersion compensation module;
a detection section that detects the ratio of the amount of the change in the wavelength deviation given by said wavelength deviation applying section to the amount of the change in the intensity of light monitored by said monitor section and the sign thereof; and
a dispersion-compensation-module passing-characteristics control section that controls the passing characteristics of said dispersion compensation module based on the ratio and sign detected by said detection section so that the amount of the change in the intensity is kept equal to a predetermined threshold value or less.

6. The optical transmission apparatus according to claim 3, wherein,
said dispersion compensation module is aperiodic dispersion compensation module having periodic passing characteristics that the pass band is a narrow band and the peak of the transmittance appears repeatedly at predetermined intervals.

7. The optical transmission apparatus according to claim 4, wherein,
said dispersion compensation module is aperiodic dispersion compensation module having periodic passing characteristics that the pass band is a narrow band and the peak of the transmittance appears repeatedly at predetermined intervals.

8. The optical transmission apparatus according to claim 4, wherein,
said light source is a light source of direct modulation type that modulates light having a transmission wavelength using a main signal by a direct modulation method, and
said wavelength deviation applying section is configured so as to give said wavelength deviation as well as said main signal to said light source.

9. The optical transmission apparatus according to claim 7, wherein,
said periodic dispersion compensation module is a dispersion compensation module of VIPA (Virtually Imaged Phased Array) type.

10. The optical transmission apparatus according to claim 7, wherein,
said periodic dispersion compensation module is a dispersion compensation module of etalon type employing an etalon filter.

11. The optical transmission apparatus according to claim 10, wherein,
said dispersion compensation module of etalon type comprises an etalon filter having a light incident surface whose light reflectance is less than 1 and a light reflection surface that reflects light that transmits said light incident surface and whose light reflectance is less than 1.

12. The optical transmission apparatus according to claim 10, wherein,
said dispersion compensation module of etalon type comprises a plurality of stacked etalon filters whose reflectance is less than 1.

13. The optical transmission apparatus according to claim 5, wherein,
said light source is a light source of direct modulation type that modulates light having a transmission wavelength using a main signal by a direct modulation method, and
said wavelength deviation applying section is configured so as to give the wavelength deviation as well as said main signal to said light source.

14. The optical transmission apparatus according to claim 6, wherein,
said periodic dispersion compensation module is a dispersion compensation module of VIPA (Virtually Imaged Phased Array) type.

15. The optical transmission apparatus according to claim 6, wherein,
said periodic dispersion compensation module is a dispersion compensation module of etalon type employing an etalon filter.

16. The optical transmission apparatus according to claim 15, wherein,
said dispersion compensation module of etalon type comprises an etalon filter having a light incident surface whose light reflectance is less than 1 and a light reflection surface that reflects light that transmits said light incident surface and whose light reflectance is less than 1.

17. The optical transmission apparatus according to claim 15, wherein,
said dispersion compensation module of etalon type comprises a plurality of stacked etalon filters whose reflectance is less than 1.

18. The optical transmission apparatus according to claim 6, wherein,
said light source is a light source of direct modulation type that modulates light having a transmission wavelength using a main signal by a direct modulation method, and
said wavelength deviation applying section is configured so as to give the wavelength deviation as well as said main signal to said light source.

19. A method for controlling an optical transmission system, in which a light source that transmits light having a certain wavelength, an optical transmission path that transmits light from said light source, and a plurality of optical relay nodes interposed in said optical transmission path and having a dispersion compensation module of passing characteristics variable type that compensates for the dispersion of the transmission light are provided, comprising the steps of:
shifting the wavelength of said light source and transferring the wavelength shift information to each of said optical relay nodes; and
controlling the passing characteristics of said dispersion compensation module based on light having passed through said dispersion compensation module of its own node and the transferred wavelength shift information so that the amount of the change in the intensity of light having passed through said dispersion compensation module is kept to a minimum at each of said optical relay nodes.

20. A method for controlling an optical transmission system in a wavelength-multiplexed optical transmission system, in which a plurality of light sources that transmit light of different wavelength, an optical transmission path that transmits light from each of said light sources as a wavelength-multiplexed light, and a plurality of optical relay nodes having a periodic dispersion compensation module having periodic passing characteristics that the pass band is a narrow band and the peak of the transmittance appears repeatedly at predetermined intervals and whose passing characteristics are variable are provided, comprising the steps of:
shifting the wavelength of any one of said light sources having a standard wavelength and transferring the wavelength shift information to each of said optical relay nodes;
controlling the passing characteristics of said dispersion compensation module based on the output light of the standard wavelength from said dispersion compensation module of its own node and the transferred wavelength shift information of said standard wavelength so that the amount of the change in the intensity of the light having said standard wavelength having passed through said dispersion compensation module is kept to a minimum at each of said optical relay nodes; and
controlling the transmission wavelengths of said light sources other than that having said standard wavelength so that the amount of the change in the intensity of light having a wavelength other than said standard wavelength having passed through said dispersion compensation module is kept to a minimum.

21. An optical relay node equipped with a wavelength control function, which is an optical relay node in a wavelength-multiplexed optical transmission system, in which a plurality of light sources that transmit light of different wavelength, an optical transmission path that transmits light from each of said light sources as a wavelength-multiplexed light, and a plurality of optical relay nodes interposed in said optical transmission path are provided, comprising:
a periodic dispersion compensation module having periodic passing characteristics that the pass band is a narrow band and the peak of the transmittance appears repeatedly at predetermined intervals and whose passing characteristics are variable;
a wavelength-shift-information reception means that receives the wavelength shift information given to any one of said light sources having a standard wavelength; and
a control means that controls the passing characteristics of said dispersion compensation module based on the output light of said standard wavelength having passed through said periodic dispersion compensation module and the wavelength shift information received by said wavelength-shift-information reception means so that the amount of the change in the intensity of light having said standard wavelength having passed through said dispersion compensation module is kept to a minimum.
